(19) United States
(12) Patent Application Publication
(10) Pub. No.: US 2009/0205878 A1
(43) Pub. Date: Aug. 20, 2009

(54) TOUCHPAD FOR PROVIDING TOUCH STICK FUNCTIONALITY IN A GAME CONTROLLER FOR PROVIDING RELATIVE AND ABSOLUTE POSITION INPUT

(76) Inventor: David Taylor, West Jordan, UT (US)

Correspondence Address: MORRISS OBRYANT COMPAGNI, P.C., 734 EAST 200 SOUTH, SALT LAKE CITY, UT, 84102, US

(21) Appl. No.: 12/350,857

(22) Filed: Jan. 8, 2009

Related U.S. Application Data
(60) Provisional application No. 61/019,760, filed on Jan. 8, 2008.

(51) Int. Cl. G08C 21/00

(52) U.S. Cl. 178/18.03

(57) ABSTRACT

A touchpad used in place of a touch stick in a video game controller, wherein the touchpad provides either absolute or relative position information to a processor, wherein the touchpad can be switched between absolute and relative position mode, and wherein the relative mode of operation cannot be performed by a touch stick, thereby adding new functionality to a video game controller.

### CROSS REFERENCE TO RELATED APPLICATIONS

This document claims priority to and incorporates by reference all of the subject matter included in the provisional patent application docket number 4171.CIRQ.PR, having Ser. No. 61/019,760 and filed on Jan. 8, 2008.

### BACKGROUND OF THE INVENTION

1. Field of the Invention

This invention relates generally to a touchpad operating in a relative or an absolute positioning mode. More specifically, the invention can be used by adding one or more touchpads or replacing one or more touch sticks (or touchsticks) with a touchpad in a video game controller, wherein the touchpads provide greater versatility in input modes and improved control regarding position input in certain gaming situations.

2. Description of Related Art

Video game controllers are used to provide input to video games played on computers or using a game console coupled to a monitor or television. Video game controllers typically have one or more touch sticks for enabling control over actions performed within the video game. Good examples of video game controllers that can be improved by application of the present invention include the Xbox® and Xbox® 360 game controllers, Playstation2® and the Playstation3® game controllers, and Wii® game controllers. However, these game consoles are examples only, and any game controller that includes a touch stick can benefit from the present invention.

A touch stick is typically an analog device that converts an analog signal to a digital signal which is used as input to a processor. The processor can be a game console or computer, but the invention should not be considered limited to gaming applications. Any device that uses a touch stick for input can benefit from the present invention. Such applications include machines in many industries.

There are various ways to obtain a signal from a touch stick in order to determine a current position of the touch stick relative to any position that can be obtained. For example, many touch sticks a have an upright or centered position that allows the touch stick to move in any direction until the touch stick reaches an edge or physical boundary. This type of touch stick has 360 degrees of freedom. Other touch sticks are confined to move within linear boundaries. What is important to understand is that the present invention can replace any type of touch stick regardless of its limitations or lack thereof of movement.

Movement of a touch stick generates signals that are generally digitized so that a digital signal is sent to a processor containing position information of the touch stick. Position information often includes two different pieces of data. The two pieces of position information may indicate, for example, how far the touch stick has been pushed away from a centered position, and in which direction, relative to its own mechanism, that the touch stick has been pushed.

Unfortunately, a touch stick is an absolute position device. What is meant by “absolute position” for the purposes of this invention is that any position that the touch stick can be moved to cannot be duplicated by any other position of the touch stick. For example, the centered position of the touch stick is always the only position that can be interpreted as the centered position. Likewise, all other positions are unique. Therefore, the only way for the touch stick to send a signal indicating that the touch stick is centered is for the touch stick to be centered.

This absolute position system is a function of the inherent nature of touch sticks. If positions could be reassigned, the touch stick would become unusable because the user would become “lost” or unable to determine where it is positioned with respect to a “homebase”, “neutral” or “centered” position.

The centered position of a touch stick is typically of critical importance because it is the one position that is considered “neutral”. For the purposes of the invention, the neutral position is the position of a touch stick that generally does not result in position information or instructions being sent to a game controller that would indicate that movement or a change in an input parameter should be taking place. Consider a touch stick that has springs or other mechanism that automatically center the touch stick when no force is being applied by a user. If a force is applied and then released, the touch stick will move back to the centered or neutral position. This neutral position is useful in many applications such as video games because the signal sent to a processor typically is indicative of a desire to not cause any action to be taken, such as movement or the changing of a visual point of view in a virtual environment. Such a neutral position is required in many games or machines when working in a non-gaming environment.

It is observed that a neutral position is critical to most games because it enables a user to stop or observe without movement. Experience has shown that the centered position is the best position of the touch stick that would function as the neutral position because it allows the maximum amount of freedom of movement of the touch stick in a subsequent move.

The technology of the present invention that is being used to replace the touch stick is a touchpad. Any touchpad technology can be used to implement the present invention. Nevertheless, it is useful to describe one embodiment of touchpad technology that can be used. Specifically, the capacitance-sensitive touchpad technology of CIRQUE® Corporation can be used to implement the present invention. The CIRQUE® Corporation touchpad is a mutual capacitance-sensing device and an example is illustrated in FIG. 1. The touchpad can be implemented using an opaque surface or using a transparent surface. Thus, the touchpad can be operated as a conventional touchpad or as a touch sensitive surface on a display screen, and thus as a touch screen.

In this touchpad technology of CIRQUE® Corporation, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode. However, the row and column electrodes can also act as the sense electrode, so the important aspect is that at least one electrode is driving a signal, and another electrode is used for detection of a signal.

In more detail, FIG. 1 shows a capacitance sensitive touchpad 10 as taught by Cirque® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. Touchpad sensor control circuitry 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touchpad sensor control circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad sensor control circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touchpad sensor control circuitry 20 is directly driving the electrodes 12, 14 of the touchpad 10. Thus, for a typical 12×16 electrode grid touchpad, there are a total of 28 pins (12+16=28) available from the touchpad sensor control circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

The underlying technology for the CIRQUE® Corporation touchpad is based on capacitive sensors. As was mentioned, other touchpad technologies can also be used for the present invention. These other proximity-sensitive and touch-sensitive touchpad technologies include but should not be considered limited to electromagnetic, inductive, pressure sensing, electrostatic, ultrasonic, optical, resistive membrane, semi-conductive membrane or other finger or stylus-responsive technology.

### BRIEF SUMMARY OF THE INVENTION

In a preferred embodiment, the present invention is a touchpad used in place of a touch stick in a video game controller, wherein the touchpad provides either absolute or relative position information to a processor, wherein the touchpad can be switched between absolute and relative position mode, and wherein the relative mode of operation cannot be performed by a touch stick, thereby adding new functionality to a video game controller.

In a first aspect of the invention, the touchpad provides digital information to a game controller input that is designed to receive digital data from a touch stick.

In a second embodiment, the game controller is optimized for receiving input from a touchpad instead of a touch stick.

In a third embodiment, a plurality of touchpads are provided in the video game controller.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

FIG. 2 is an illustration of a video game controller that is used for the Xbox® 360 game console, showing two touch sticks.

FIG. 3 is an illustration of a video game controller that is used for the Xbox® 360 game console, but which is modified by replacing the touch stick controllers with touchpads.

FIG. 4 is an illustration showing how a gun sight responds to a touch stick in absolute mode.

FIG. 5 is a top down view of a game controller showing force is being applied to the touch stick to generate movement of the gun sight as shown in FIG. 4.

FIG. 6 is an illustration showing how a gun sight responds to a touchpad in relative mode, while moving a pointing object in the same direction as the arrow 64 in FIG. 5.

FIG. 7 is a top down view of a game controller showing how a pointing object is moved along the touchpad to generate movement of the gun sight as shown in FIG. 6.

FIG. 8 is a top down view of a game controller showing both touchpads and touch sticks in the same game controller.

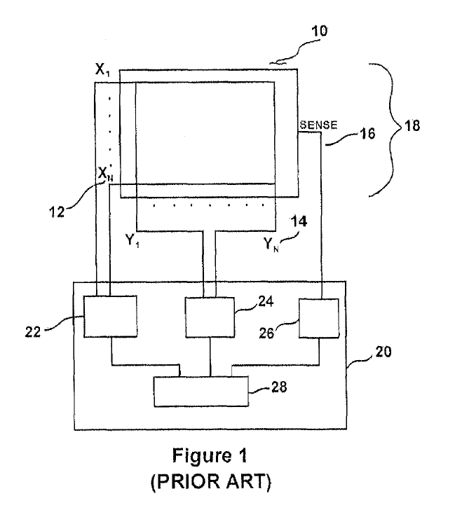

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

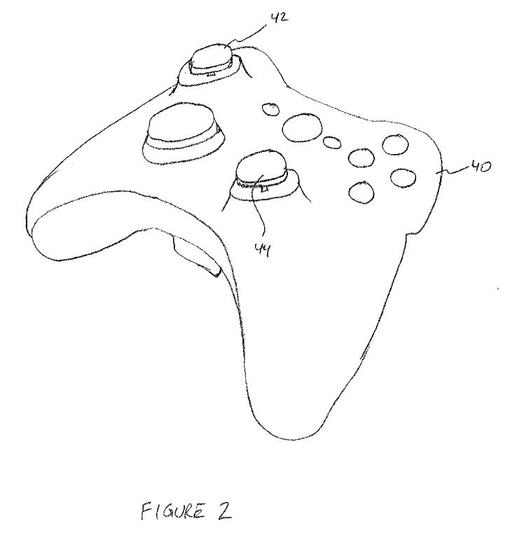

FIG. 2 is a perspective view of an Xbox® 360 game controller 40 that is used with the Xbox® 360 game console (not shown). The device shown is wireless but can also be wired for the present invention. It should be understood that the present invention is not limited to only this game controller or game console. Any application or device including a game controller that uses an input device operating in an absolute mode can be replaced by the present invention in order to provide a new interface that operates in either absolute or relative position mode.

This particular game controller 40 includes two touch sticks 42, 44, as well as other controls that are not material to the present invention. In this first embodiment, the two touch sticks 42, 44 are replaced by two touchpads. There is sufficient space on the game controller 40 to include the touchpad replacements without adjusting the placement of other controls. However, the other controls may be moved if desired.

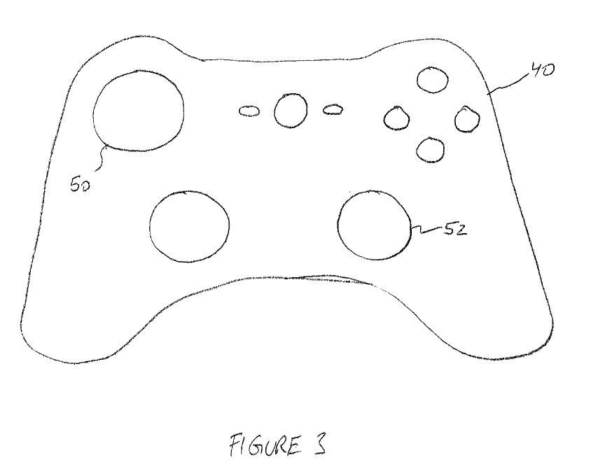

FIG. 3 is a top elevational view of the game controller 40 with touchpads 50, 52. The touchpads 50, 52 are shown as being round in shape. The shape of the touchpads can be changed as desired. However, a circular touchpad will fit best within the space previously allocated to the touch sticks because the housing for the touch sticks is circular. However, the touchpads can be any convenient shape, such as circular, oval, rectangular or square. These examples should not be considered limiting. The touchpad 50,52 could be omnidirectional, be restricted to a specific axis or to multiples axes.

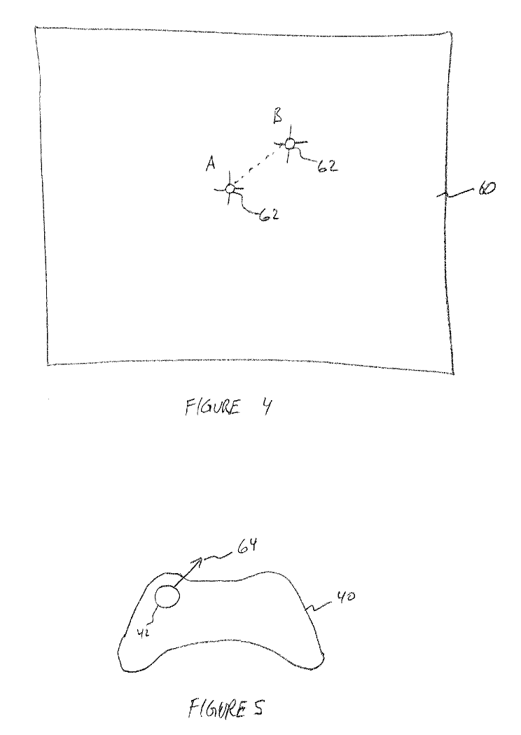

FIG. 4 is provided as an illustration of a display screen 60 showing a gun sight 62 that is first located in the center of the display screen. This illustration shows the movement of the gun sight 62 if a touch stick, such as touch stick 42 or 44 is in control of the gun sight and is moved in the direction indicated by arrow 64 in FIG. 5. What is demonstrated is that movement of the touch stick 42 corresponds to a similar movement of an object on the display screen 60, in this case the gun sight 62.

It was also previously explained that “movement” is simply one input parameter, and that the touchpads 50, 52 can provide input to any input parameter such as one controlling a direction of view instead of movement.

A significant aspect of an absolute position touch stick is that as soon as the user removes a force from the touch stick 42, the touch stick will center itself using springs or a similar spring mechanism inside the game controller 40. When a force is first applied to the touch stick 42, the gun sight moves from position A to position B as shown in FIG. 4. Upon release of the touch stick 42, the gun sight 62 will move back to position A as the touch stick centers itself.

It is noted that movement of the gun sight 62 may vary if it is not immediately released upon reaching position B. In other words, some programs may make the gun sight 62 continue movement in the direction sent by the touch stick 42 until the touch stick is centered. This is not relevant to the absolute and relative position information being discussed. What is important to remember is that the gun sight 62 cannot remain at position B unless the user holds the touch stick 42 at a specific non-centered position. It is noted that the gun sight 62 will continue to move further in the same direction until the touch stick 42 moves the maximum limit of movement until a physical barrier such as the edge of the touch stick controller is reached, typically defined as the edge of its housing.

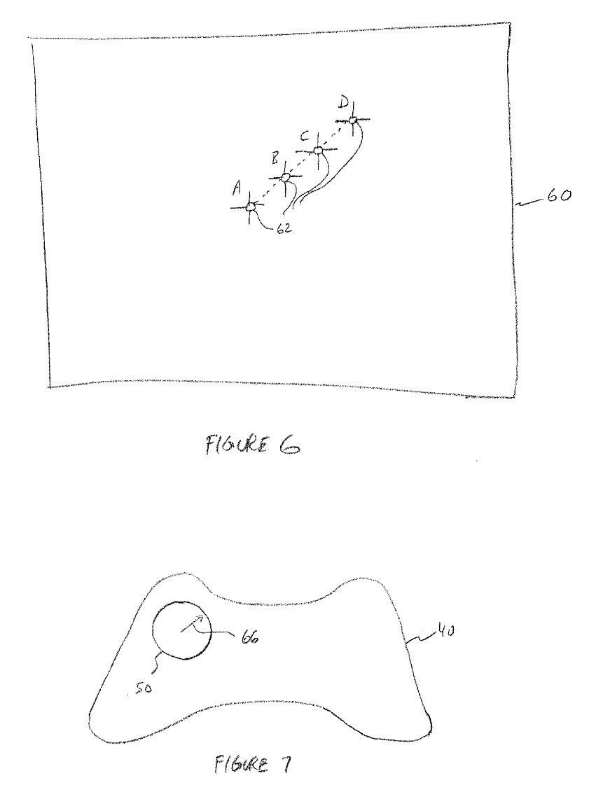

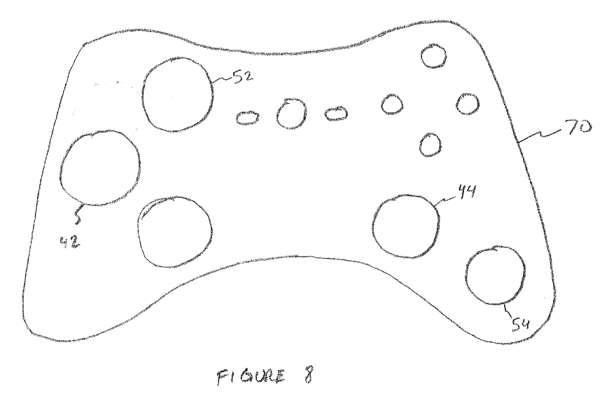

FIG. 6 is provided as an illustration of a display screen 60 showing a gun sight 62 beginning movement from the center of the display screen. This illustration shows the movement of the gun sight 62 if a touchpad, such as touchpad 50, is in control of the gun sight and a pointing object, such as a finger, makes contact anywhere on the touchpad, and is then moved in the direction indicated by arrow 66 in FIG. 7. Thus, while the arrow 66 originates from a center of the touchpad 50 in FIG. 7, this is for illustration purposes only, and the arrow 66 can originate in any location that still enables movement in the direction indicated.

There are some important aspects of the invention that should be noted. First, there is no neutral position on the touchpad 50. Anywhere that the pointing object touches down on the touchpad 50 just becomes a position from which the pointing object will begin movement. Thus, there is no neutral location on the touchpad 50 that needs to be remembered. What is demonstrated is that movement of a pointing object on the touchpad 50 corresponds to a movement of an object 50 on the display screen 60 just as with a touch stick of the prior art, which in this case is the gun sight 64. But more importantly, there is no movement of the gun sight 62 when the pointing object completes its movement and is then lifted off of the touchpad 50. Removing force from a touch stick would cause the gun sight 62 to snap back to a position represented by the neutral position of the touch stick. In contrast, there is never a “snapping back” movement caused by lift off of a pointing object from a touchpad.

Accordingly, a significant aspect of a relative position touchpad 50 is that as soon as the user stops moving a pointing object on the touchpad, there is no mechanical spring that must center a physical object as is the case with a touch stick. The gun sight 62 will remain where it was positioned on the display screen 60 when the pointing object is lifted off the touchpad 50. Thus, the gun sight 62 is shown as moving from position A to position B. Subsequent touchdowns and then movements of a pointing object on the touchpad 50 in the direction of arrow 66 will continue to move the gun sight 62, first from position B to position C, and then from position C to position D.

It is noted that the amount of movement of the gun sight 62 or other object on the display screen can be adjusted. In other words, a very small amount of movement of a pointing object on touchpad 50 can correspond to relatively long or short distances of movement of an object on the display screen 60. When precise or fine control is desired, then it may be the case that long movements on the touchpad 50 will correspond to very small movements on the display screen 60. In contrast, very short distance movements on touchpad 50 can also result in very long distance movements on the display screen 50. But what is important is that the degree of change to a parameter that in this case represents a change in location of an object on the display screen 60 can be adjusted as desired.

It is also important to understand that a touch stick cannot mimic this ability of changing a relative position by using a touchpad. It is the nature of a touch stick to have to center itself after movement so that a subsequent movement after centering enables the greatest amount of movement possible for the touch stick. To emulate the relative position action of the touchpad 50, a touch stick would have to snap back to its center position without causing movement of the gun sight 62. The touch stick would therefore have to be released by the user, and the program would have to ignore movement of the touch stick until reaching the center position. Obviously, this type of action would prevent the user from controlling game play during this re-positioning of the touch stick to the neutral position.

Another drawback of this approach is that any movement of the touch stick towards the neutral position would have to automatically terminate movement or changing the value of the input parameter being controlled. In contrast, a touchpad has no such limitation, and movement back towards the neutral position would simply be seen as a reversal in the value of the input parameter being controlled.

It is also noted that the touchpad can also operate in an absolute positioning mode, where lifting the pointing object off the touchpad would cause the gun sight 62 to center itself even though no physical object is actually being moved. Thus, the touchpad would be operating as a virtual touch stick, depending on how the user wanted to interact with the game. Thus, while the touchpad could operate as a touch stick, the reverse is not true.

Alternatively, it is noted that the gun sight 62 can remain centered in the center of the display screen 60. When force is applied to the touch stick 42, 44 or touchpad 50, 52, the entire viewpoint of the user moves, or in other words, the view of the user of the virtual environment changes. This is also a common application of touch sticks in video games.

In the scenario where a viewpoint is being changed, it is as if a camera or eyes are being controlled, and this camera gives a user a view of another location which is shown on a display screen. When a touch stick is being used, the view will typically continue to pan (or movement will continue) in whatever direction the view was moving before the touch stick was stopped. Thus, the touch stick is being held motionless in a certain position that is non-centered, but the view continues to move. With a touchpad operating in a relative position mode of operation, this would not occur. When the user stops moving the pointing object on the touchpad, the view will also stop. Nevertheless, there is a way to make a touchpad operating in the relative position mode to act as if operating in an absolute mode, but only when an outer boundary or perimeter of the touchpad is reached.

Thus, a final aspect of the invention is the inclusion of what is called edge motion on a perimeter of the touchpads 50, 52. Edge motion is the function that is activated by moving a pointing object on a touchpad to an outer edge. When the pointing object reaches an outer edge, the user stops moving the pointing object, but the action continues. For example, if the user is changing a point of view with a relative position touchpad, stopping the pointing object will cause the view to also stop moving. With edge motion, reaching the perimeter of a touchpad causes the view to continue moving in whatever direction the view was moving when the pointing object made contact. Thus, edge motion gives a touchpad operating in a relative mode the ability to act as if it is operating in an absolute mode.

Another aspect of the present invention is shown in FIG. 8. FIG. 8 shows another possible example of a modified video game controller 70. In this controller 70, the touch sticks 40, 42 have not been removed or replaced, but are left in the controller. The position of the touch sticks 40, 42 may or may not be moved to assist with access. In this figure, touch stick 42 is moved, and touch stick 44 is not. However, two touchpads 52, 54 are now inserted in to the controller 70, giving the user the option of using either type of interface. Thus, a touchpad can replace a touch stick or it can be added to a controller to provide an optional interface method.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for controlling an input parameter in a game controller device, said method comprising the steps of:
1) providing a touchpad on the game controller for controlling the input parameter;
2) touching down on the touchpad with a pointing object;
3) moving the pointing object along a surface of the touchpad, wherein a value of the input parameter changes according to the movements of the pointing object;
4) wherein moving the pointing object causes a change in the value of the input parameter, and stopping the pointing object causes no change in the value of the input parameter; and
5) wherein lifting the pointing object off the touchpad causes no further no further change in the value of the input parameter such that the touchpad operates in a relative position operating mode.

2. The method as defined in claim 1 wherein the method of controlling the input parameter further comprises the step of controlling a parameter of a virtual environment.

3. The method as defined in claim 2 wherein the method of controlling a parameter of a virtual environment further comprises the step of controlling an input parameter from the group of input parameters including movement of a character within the virtual environment and changing a point of view within the virtual environment.

4. The method as defined in claim 1 wherein the method of further comprises the step of providing relative position input, wherein a value of the input parameter is not controlled by the location of a beginning point of movement on the touchpad.

5. The method as defined in claim 1 wherein the method of further comprises the step of providing absolute position input, wherein a value of the input parameter is controlled by the location of a beginning point of movement on the touchpad.

6. The method as defined in claim 1 wherein the method further comprises the step of continuing a change in the value of the input parameter whenever the pointing object stops movement because the pointing object reaches an outer boundary of the touchpad.

7. A game controller for controlling an input parameter in a game controller device, said game controller comprised of at least one touchpad on the game controller for controlling the input parameter, said at least one touchpad providing position information regarding the location of a pointing object on the touchpad, wherein a change in position of the pointing object results in a change in the value of the input parameter, and wherein stopping movement of the pointing object causes no change in the value of the input parameter; and wherein lifting the pointing object off the touchpad causes no further no further change in the value of the input parameter such that the touchpad operates in a relative position operating mode.

8. A method for providing relative movement of an object within a virtual environment, said method comprising the steps of:
1) providing a touchpad on a game controller for controlling movement of an object within a virtual environment, wherein the virtual environment is shown on a display screen;
2) touching down on the touchpad with a pointing object;
3) moving the pointing object along a surface of the touchpad, wherein movement of the object within the virtual environment is controlled by the movement of the pointing object;
4) wherein moving the pointing object causes movement of the object within the virtual environment, and stopping movement of the pointing object causes movement of the object within the virtual environment to cease; and
5) wherein lifting the pointing object causes no further movement of the object within the virtual environment.

9. The method as defined in claim 8 wherein the method further comprises the step of changing a view of the virtual environment, wherein moving the pointing object causes movement of the point of view within the virtual environment, and stopping the pointing object causes movement of the point of view within the virtual environment to cease.
